(19) United States
(12) Patent Application Publication
(10) Pub. No.: US 2005/0259658 A1
(43) Pub. Date: Nov. 24, 2005

(54) Mail, package and message delivery using virtual addressing

(76) Inventors: James D. Logan, Candia, NH (US); Charles G. Call, West Yarmouth, MA (US)

Correspondence Address: CHARLES G. CALL, 68 HORSE POND ROAD, WEST YARMOUTH, MA, 02673-2516, US

(21) Appl. No.: 11/198,124

(22) Filed: Aug. 6, 2005

(51) Int. Cl. H04L 12/28

(52) U.S. Cl. 370/392

(57) ABSTRACT

A cross-referencing server connected to the Internet stores cross-references between different address designations for the same person, entity or location. The address designations stored in each cross-reference can include a unique shorthand string of characters used as a virtual address for a particular person, entity or location, and also the mailing address and telephone and fax numbers, email address, or Internet URL(s) associated with that person, entity or location. The server can be employed to translate any of the stored address into a different address. As examples, a letter could be addressed using the recipient's shorthand virtual address, her phone number or her email address, or an email message could be sent to a phone or fax number,

### FIELD OF THE INVENTION

This invention relates to methods and apparatus for transmitting physical things and information via the mail, other carriers, and electronic communication systems.

### SUMMARY OF THE INVENTION

The following summary provides a simplified introduction to some aspects of the invention as a prelude to the more detailed description that is presented later, but is not intended to either define or delineate the scope of the invention.

It is one object of one aspect of the invention to simply the transmission of physical items and information to destinations by simplifying the manner in which those items and information are addressed.

It is a further object of another aspect of the present invention to provide many of the advantages provided by the electronic transmission of email to those who use the services of postal services and other carriers.

It is still another object of some embodiments of the invention to simplify the task of addressing an item or data object for delivery by more easily identifying its destination, routing the item or data object to the identified destination, providing data to authorized persons describing such the status and history of individual deliveries, and describing the persons or entities who send and receive such deliveries.

In preferred embodiments of the invention, a cross-referencing server which can be accessed via the Internet stores relationships between a virtual address designation, one or more physical locations, and other identifiers designating persons, entities or locations such as email addresses, phone or fax numbers, or identification codes. The virtual address preferably comprises a character string which is selected from a group consisting of:
(a) a short, descriptive, unique identifier of a person, entity or location, such as “BOB JONES IN NEWARK,” “AJAX MUFFLERS,” “NAPLES NANCY”, etc.; or
(b) an existing identifier of a person, entity or location such as a telephone number, a cellular phone number, a Global Location Number, a DUNNS+4 number, an email address, etc.

An automated physical item routing and delivery system may employ the cross-referencing server to route a physical item for delivery to a physical address associated with and designated by a virtual address that is supplied by the sender to designate the recipient. The cross-referencing server responds to request messages containing a virtual address designating a destination and returns routing information, such as the postal ZIP code of that destination, to the routing system to properly direct the item to its final physical destination.

The cross referencing facility may further advantageously store additional information related to each virtual address, including some or all of the following:
(a) information describing the person or entity (hereinafter called the “OWNER”) that has registered the virtual address and supplied at least some of the information which stored for and is associated with the virtual address;
(b) information describing the physical location currently associated with a virtual address, or potentially associated with a virtual address, including the mailing address and preferably the geographic coordinates of each physical location;
(c) rules governing the operations performed using each given virtual address including special routing instructions which are to be followed under particular conditions;
(d) alternative address designations or identifiers, including email addresses, a phone and/or fax numbers, Internet addresses, and identification codes that designate people, entities or places. These alternative designations may be used by forwarding mechanisms so that physical deliveries, email, phone calls, fax transmissions can be automatically routed, and Internet connections established, using available addresses or identifiers normally used with other services; and
(e) a variety of other data which can be accessed using virtual addresses and associated alternative designations or identifiers to facilitate and manage deliveries of physical items and messages and other forms of exchange between persons, entities or locations designated by such addresses.

These and other objects, features and advantages of the present invention may be more clearly understood by considering the following detailed description of specific illustrative embodiments of the invention.

### BRIEF DESCRIPTION OF THE DRAWINGS

In the detailed description which follows, frequent reference will be made to the attached drawings, in which:

FIG. 1 is a block diagram illustrating the principle function components that play a role in the new methods of delivering physical items contemplated by the invention.

### DETAILED DESCRIPTION

Simplifying Addressing

Most people and business have several addresses at which they can be reached: a mailing address, an email address, phone and fax numbers, and Web addresses. Most of these addresses are hard to remember, can change from time to time, and cumbersome to use. The present invention makes addressing easier by enabling people and businesses to adopt a descriptive and easy to remember “virtual address” that can be used to send regular mail, to send packages via couriers and other carriers, to send email messages, to place phone calls, to send fax messages, and to access information and services via the Internet. The invention also makes it possible to use existing email addresses, phone and fax numbers, Internet URLs or other designations when shipping or mailing physical items or to sending data using delivery systems other than the system for which the address was intended.

Thus, as described in detail below, a shorthand virtual address like “NANCY JONES IN PLYMOUTH” may be used as a destination address for regular mail, a package sent by a delivery service, an email message or a Fax transmission, or used to place a phone call or connect to a Web site or Web service. In addition, a person's existing phone number can be used without more as a physical delivery address, an email address, or an Internet address. Similarly, an email address may be used instead of a phone number to place a phone call or send a fax, or used as a mailing or delivery address for the shipment of physical items.

These and other capabilities to be described are made possible by storing cross-referencing information on the Internet which allows a requestor who knows one of these addresses for any person or business, to obtain any of the other addresses which the person or business chooses to make available. Thus, knowing the virtual address “NANCY JONES IN PLYMOUTH,” a requestor (which may be the postal service, another carrier, a phone company, an email client or server, or any other authorized entity

Providing the Advantages of Email

The embodiment of the invention described below provides a number of useful advantages which are now available to those sending and receiving email, but which are typically not available when sending and receiving physical shipments, like letters, packages and other items commonly shipped using the postal service or other carriers. The advantages of present invention are provided by a combination of techniques, one of which is the use of unique identifiers (here called “virtual addresses”) which designate senders and receivers of physical items being shipped. These advantages include the following:

1. Just as email directed to a specific email address can be automatically routed to a destination mailbox designated by the owner of the email address, physical items can be routed to a destination location designated by the owner of a virtual address.

2. Just as a person can own and be designated by several different email addresses, a person can also own several different virtual addresses and physical shipments to each virtual address can be routed to the same or different physical locations as specified by the virtual address owner.

3. As with email, a person can change virtual addresses and shipments can be rerouted to that new address so senders need not change their existing contact lists.

4. Like email addresses, virtual addresses are not permanently associated with a particular location, and the address holders do not reveal their actual physical address or location by disclosing a virtual address.

5. Like email addresses, virtual addresses are shorter, easier to remember, and easier to use that length physical addresses that typically consist of at least a name, street address, city, state and zip code.

6. Software using an auto-fill ability allowing the person entering a virtual address to type in as little as a single character to address an item for shipment.

7. Just as an email address can form a shorthand description of the address owner (e.g., webmaster@pepsi.com or charlie@.com), a person can be allocated a descriptive virtual address of his or her choosing (as long as it's unique).

8. Many email server and client programs provide mechanisms for blocking the receipt of undesired email, and the present system likewise permits holders of virtual addresses to block the delivery of undesired physical items directed to a given virtual address.

9. email server and client programs often provide the ability to assign a priority value to email of particular kinds, and the present system likewise allows the delivery of physical items to be prioritized or handled in particular ways in accordance with rules specified by the virtual address holder.

10. email users can often handle email from different senders differently; likewise, virtual address holders can control the routing and handling of physical deliveries by establishing, for example, different rules for different senders.

11. Just as an email user can elect to leave incoming email on a mail server until later, a virtual address holder can direct that incoming physical items be held for later delivery until requested.

13. Very large numbers of email messages can be stored, sorted and processed, and the present system is capable of storing, sorting and processing information on very large numbers of physical shipments.

14. A recipient of an email message can reply or otherwise communicate with the sender knowing only the sender's email address, and virtual addresses can likewise be used to establish communications between senders and recipients using the virtual addresses alone.

15. In an email system, and in the virtual addressing system described here, the holder of an address can modify information which identifies the address holder and controls how the address is used in a secure manner using password protected access.

System Overview

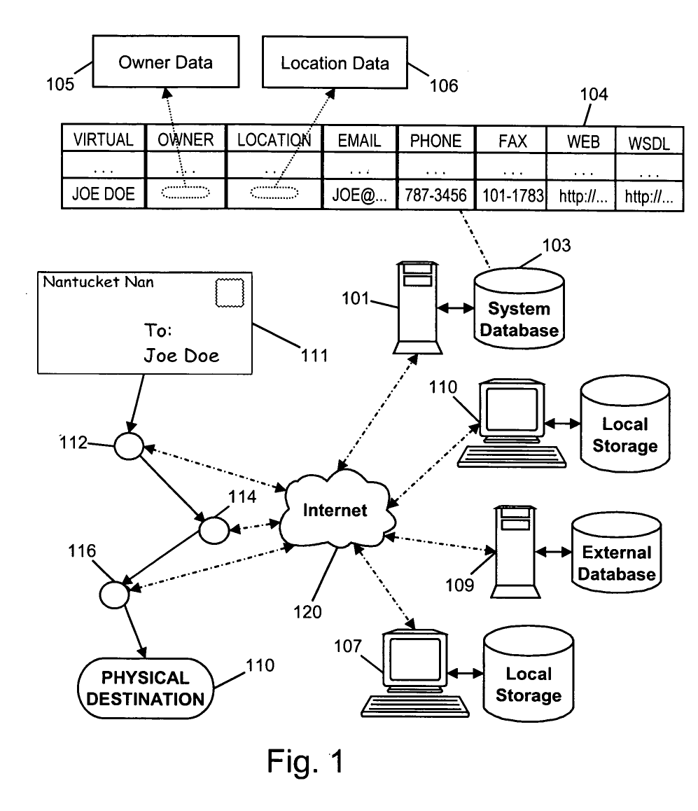

The principal functional components used in a preferred embodiment of the invention, and their relationship to one another, is illustrated in FIG. 1 of the drawings. The overview description which follows provides an introduction to one illustrative architecture for a physical item delivery system using virtual addresses.

The system uses a registration server 101 (or several servers such as a Web server and several database servers) to populate and maintain a registration database 103 that stores relationships between identifiers (virtual addresses, email addresses, phone numbers, Internet addresses, etc.) and other data related to those identifiers. These relationships may be stored in many different ways and, for purposes of illustration, are described below as relational database tables. As used herein, the term “virtual address” is used to designate identifiers supplied by participating users which usually take the form of descriptive shorthand character strings composed by the users, but may be any unique string, such as a telephone numbers or email addresses. Existing unique identifiers like telephone numbers, email addresses, company codes, etc. may also be registered as additional identifiers associated with a virtual address, or may be registered as a virtual address string, or both.

The first table, called the ACCESS TABLE, seen at 104 in FIG. 1 and further illustrated by the example table below, contains one row for each entity and contains “identifiers” which designate that entity as well as pointers (e.g. relational keys) for identifying data in two other tables 105 and 106 that identify additional data relating to that entity. Each row preferably includes a unique virtual address (seen in the first column) which acts as one of the high speed access keys for the table. The second column contains an OWNER KEY which identifies data in the OWNER DATA TABLE seen at 105 in FIG. 1 and further illustrated by the example below that contains information about the owner of the virtual address specified in the first column. The third column contains a PHYSICAL LOCATION KEY which identifies a data record associated with each virtual address in a LOCATION DATA TABLE seen at 106 also illustrated by an example below.

It should be understood that the example tables below are illustrative only and, to conserve space, do not show all of the data columns or data that would be used in a working installation. Other data, such as data describing rules and privacy permissions, is not included in the illustrative tables below which serve as an introductory illustrative tutorial.

ACCESS TABLE

| | | PHYSICAL | | | | | |
|---|---|---|---|---|---|---|---|
| VIRTUAL | OWNER | LOCATION | | | | | |
| ADDRESS* | KEY* | KEY* | EMAIL* | PHONE* | FAX* | WEB | WSDL |
| . . . | | | | | | | |
| JOE DOE | 123456949 | 674536452 | jdoe@yahoo.com | 508- | 508- | {URL} | |
| | | | | 555- | 555- | | |
| | | | | 1134 | 5873 | | |
| . . . | | | | | | | |
| NANCY | 345678230 | 345678230 | njones@pobox.com | 312- | 312- | {URL} | |
| JONES | | | | 678- | 765- | | |
| | | | | 9876 | 1234 | | |
| . . . | | | | | | | |
| PAINLESS | 123456949 | 903563426 | doe@dentistry.com | 508- | 508- | {URL} | {URL} |
| JOE | | | | 999- | 999- | | |
| | | | | 1200 | 1201 | | |

USER DATA TABLE

| | | OTHER | |
|---|---|---|---|
| OWNER | DISPLAY | OWNER | LOCATION |
| KEY* | NAME | DATA | NO. |
| . . . | | | |
| 123456949 | Joe Doe | See specification | 845637942 |
| . . . | | | |
| 345678230 | Nancy Jones | See specification | 674536452 |
| . . . | | | |

LOCATION DATA TABLE

| LOCATION | | | | | LOCATION |
|---|---|---|---|---|---|
| KEY | ZIP + 4 | LAT. | LONG. | PRINT AS | DATA |
| . . . | | | | | |
| 674536452 | 02673-2516 | 41° 43′ 41 N | 71° 8′ 03 W | John Doe . . . | (varies) |
| . . . | | | | | |
| 345678230 | 60603-1234 | 41° 47′ 12 N | 87° 45′ 59 W | Nancy | (varies) |
| | | | | Jones . . . | |
| . . . | | | | | |
| 903563426 | 02673-2110 | 41° 43′ 44 N | 71° 8′ 09 W | | (varies) |
| . . . | | | | | |

The three tables illustrated above may be maintained and populated by a server indicated at 101 in FIG. 1 operated by the postal service, a particular carrier or communications network, or operated as a shared facility that used by a number of different carriers, communications networks, other services, and the public. The data stored in the tables allows virtual addresses and other identifiers to be used to deliver physical items and data via multiple carriers and communications services, as well as used for other purposes as described below.

One or more servers seen at preferably provides, among other functions, a Web server interface that enables computers equipped with standard Web browsers, such the computer seen at 107, to access and submit Web forms that enable users to register a desired virtual address, and to supply and update data which can be thereafter be accessed in a variety of ways by others for a variety of different purposes. Functions such as entering a temporary address change, registering new virtual addresses (e.g. as “vanity names”), or setting or modifying privacy settings (for instance, precluding everyone except specified authorized users from obtaining physical address information corresponding to a given virtual name) may be made on-line by accessing the website. At this website, registrants may enter a password and ID allowing them secure access that permits the information, permissions and processing rules relating to a given virtual address to be modified.

The data in database 103 is made available via one or more servers 101 and the Internet 120 for programmatic access by other computers, as illustrated by the second server 109 and a workstation 110. Computers which access the data in database 103 may include, for example, routing and delivery systems operated by a postal service or other carrier, a communications network such as a telephone or cellular telephone network that uses the data in database 103 to route calls to particular phone numbers when supplied with other identifiers associated with those phone numbers in the database 103, email client and server programs which use the database 103 to route email messages to particular email addresses when supplied with other identifiers associated with those email addresses. In addition, businesses that send and receive physical shipments and messages may employ the data in database 103 to address, track and record those shipments and messages. These are, of course, examples only of many possible uses of the data in the database 103 that can be implemented using computer-to-computer exchange of data with the database 103.

The relational tables illustrate the kind of information structures that may be maintained to provide a variety of functions. The ACCESS TABLE 104 provides an access mechanism that provides data associated with a given virtual address to be rapidly retrieved from the ACCESS TABLE, as well as access to data from the OWNER DATA TABLE 105 which relates to or describes the owner of the given virtual address and/or from the LOCATION DATA TABLE 106 which relates to or describes physical locations which are logically associate with the given virtual address.

The ACCESS TABLE 104 is indexed on multiple columns, thus allowing rapid access to data relating to a particular virtual address, a particular email address, a particular phone number, or a particular fax number since all four columns containing these identifiers are indexed. Note that a given row need be populated with only one of these identifiers, and can be accessed by any identifier for which data has been inserted into the table. Thus, the row containing the virtual address “JOE DOE” can be accessed by that virtual address, and also by the associated email address “jdoe@yahoo.com” by the associated phone number “508-555-1212,” and by the associated the fax number “508-555-5873”. Cellular phone numbers may be placed in a separate column, or in the same column as other telephone numbers as illustrated by the “Phone” column in the Example Access Table above and in FIG. 1. Wireline phone numbers, telephone numbers and fax numbers are unique (that is, a specific phone number assigned to a wireline phone will not be reassigned to a cellular phone or to a different fax subscriber line), and may therefore be placed in a single column. However, because a single owner may frequently use different wireline phone, cellular phone and fax numbers, three different columns may be used in each access table row to contain data for these three types of phone numbers. These and other variations can accommodate the needs of specific applications.

Those columns in the ACCESS TABLE marked with an asterisk “*” in the column heading in the example above are indexed for high speed access, and the data value placed in each of the high speed access columns must be unique within that column. For example, if a given email address is used to refer to a particular row, that same email address cannot be placed in the email column in a different row. The relational keys placed in the OWNER KEY and LOCATION KEY column correspond to key values in the indexed OWNER KEY column of the OWNER table 105 and in the indexed LOCATION KEY column of the LOCATION table 106 respectively. In this illustrative example, the Web and WSDL columns of the ACCESS TABLE 104 which respectively hold the URL of a Web page associated with an entity, or the URL of a Web Services Description Language XML document that may be retrieved to access and use one or more Web services associated with the entity. The Web and WSDL columns of the ACCESS TABLE are not indexed since the included URLs are seldom used to access a particular row, but could be indexed if high speed access to data using these URLs as search keys was desired. Note that the URL in the Web column may be used to implement a mechanism built into a Web browser, or implemented with a Web browser add-in applet or the like, which permits virtual addresses, phone numbers, email addresses, or other unique identifications to be entered in the URL “address” field, or contained in a link. The Web browser or add-in would be activated by first testing the string entered into the address field to determine if that string satisfies the format rules for a particular kind of identifier (e.g., virtual address, phone number, or email address) and, if so, a query is transmitted to the remote server to determine if that identifier has been registered and associated with a web page URL. If the query returns the URL of an associated web page, the browser would automatically fetch that page. Thus, telephone numbers, email addresses and virtual addresses may be used as web page identifiers. In the same way, the system may be used to identify and connect to one or more web services specified in the WSDL file identified by the URL entered into the WSDL column of the access table.

By accessing a given row using any of the high speed access keys (virtual name, email address, phone number, or fax number), a requester (to the extent authorized to do so) may obtain information about the physical location currently referred to by those identifiers; allowing access to all of the virtual addresses owned by a given owner as well as data relating to the locations referred to by those addresses; and also allowing access to all of the virtual addresses currently associated with a given physical location as well as information about the owners of those virtual addresses.

The data in the database 103 may be accessed in robust ways by those authorized to do so. If the data is organized in relational tables, SQL queries may be used to extract data in substantially any way desired. For example, since the LOCATION DATA table includes data giving the geographic coordinates of a particular location specified in a particular row of that table, and that row is related by the LOCATION KEY value to a row of the ACCESS TABLE which is, in turn related to a row in the OWNER TABLE, the database 103 may be used to obtain the telephone number of all registered owners meeting specified criteria and located within a particular range of a particular map location. The results of that query can be used to as described in James D. Logan U.S. Pat. No. 6,788,766 issued Sep. 7, 2004 to establish communications between consenting participants having common interests in a given geographic region.

The VIRTUAL ADDRESS TABLE is stored in the registration database and permits the server 101 to respond to request messages which specify a virtual address or other identifier by returning to the requester the identification of a destination location currently associated with the specified virtual address. In the embodiment shown in FIG. 1, this virtual-to-physical address lookup capability is used by one or more carriers (such as the postal service or a commercial delivery service) to route a physical item to a physical destination indicated at 110 in FIG. 1. Routing is accomplished by routing the item 111 through a sequence of routing nodes 112, 114 and 116 in the carrier's delivery system.

In the illustrative example seen in FIG. 1, a physical item (such as a letter or a package) labeled “TO: JOHN DOE” is supplied to the carrier and processed by the first node 112 by routing the item to a second node 114. Routing is accomplished at the node 112 by capturing the virtual destination address (typically by optically scanning the item's address label using character recognition or by manual keyboarding) and by sending a request message containing the captured virtual address via the Internet 120 to the server 101. The server 101 responds by consulting the ACCESS TABLE 104 to determine the LOCATION KEY that corresponds to the received virtual address “JOE DOE,” and then consulting the LOCATION TABLE 106 to obtain the ZIP+4 code for that location, and returning the ZIP code data to the node 112. The destination ZIP+4 code is all the requesting routing node 112 needs to determine the next node (node 114 in the example) to which the item should be shipped.

The same process is performed at the intermediate distribution node 114 which again captures the virtual address off of the item 111, obtains the destination location as indicated by the returned ZIP code from the server 101, and ships the item 111 to the terminal node 116 (which is identified by the ZIP code). At the final node 116, the ZIP+4 code is used to determine the routing of item 111 for delivery, typically by truck, to the final destination.

This process is compatible with the existing routing methods used by postal services which typically scan the destination address on each mail item received for shipment, determine the ZIP+4 code of the destination, and then print a postal address bar code on the item itself which encodes the ZIP+4 code and a two digit indication of the specific mailbox location, such as the last two digits of the street number or the unit number of an apartment building. This printed barcode is then used by sorting equipment to route the item to the next node or deliver it to the final destination. By using the present invention to scan a shorter virtual address, email address, phone or fax number placed on the item to indicate the destination, the information needed to print the postal bar code on the item may be fetched from the database 103 and the item thereafter routed in the usual way.

As an alternative, a mailing label may be attached to the item either on receipt by the carrier or by the sender before delivery to the carrier by first capturing the virtual address, phone or fax number, or email address by scanning the item or manual keyboarding, and then by printing a label containing information fetched from the database 103 including the full printed mailing address of the destination which can be read by humans and a postal zip code that can be read by sorting equipment.

As still another alternative, a barcode or RFID label which carries only an identification number (such as the numeric LOCATION KEY value from the ACCESS TABLE) may be placed on the package by the shipper or the carrier. In this way, the identity and the location of the recipient cannot be determined by anyone other than those authorized to access data in database 103. At each routing node 112-116, the value on the label is captured, used to access the database 103 which returns routing information (e.g. ZIP+4 data) to the routing node, and the package is delivered to the destination without ever bearing a human readable destination address.

The OWNER DATA column in the OWNER TABLE 105 may hold a pointer to a much larger data structure, such as an XML document, that can contain information about an owner. Note that the ACCESS TABLE 104 may be used to identify all of the virtual addresses currently owned by that owner because all virtual address rows in the ACCESS TABLE will have the same OWNER KEY value. The OWNER DATA is typically supplied by the owner during an initial registration process and may include such things as: the billing address of the owner which may be (but need not be) itself a virtual address; credit card billing information; other contact information for the owner including an email address, telephone number(s), facsimile numbers, paging numbers, Instant messaging addresses, and the like.

Information stored in the OWNER DATA and the LOCATION DATA fields, like all other data in database 103, may be subject to access constraints, so that only authorized persons may access selected information from the database 103. For example, credit card information would typically be restricted so that it can be accessed only for the purpose of billing the owner for the use of the system. Other data, such as address information about the user, may be made available on a limited basis to only those authorized persons who present a password (made available by the owner), or who are indicated as being authorized recipients by permission data stored with the OWNER DATA. The access privileges and constraints associated data in a given row may be placed in a separate column (not shown) of that row.

Rules-Based Delivery

The delivery of physical items and messages may be prioritized or handled in particular ways in accordance with rules specified by the owner, and rules can also be established to control the routing and handling of physical deliveries and messages by establishing different procedures for different senders. Conditional Rules can be stored governing the routing of items directed to particular virtual addresses or physical location whereby, if the condition is satisfied, items directed to a specified virtual address (or physical location currently associated with that virtual address) may be redirected to a different virtual address or physical location. The condition part of such a rule may specify different calendar days or times of day so that, for example, an item to be delivered at night to a designated office location might be automatically redirected after business hours to the owner's home. The condition part may specify the virtual addresses or other designations of one or more senders, and items from these senders may be rerouted in a particular way (including being automatically returned to the sender's virtual address, providing the functional equivalent of an “anti-spam” barrier against unwanted deliveries from particular sources). These and other processing rules may be stored in the OWNER DATA section if they are to be applied generally to functions performed on behalf of the owner, or if they are to be performed with respect to deliveries from or to a particular virtual address, whereas rules that are applicable to a particular physical location are best stored in the LOCATION DATA section.

The OWNER DATA section may include one or more location keys to identify data about locations which are commonly used by that owner, even though those locations may not be currently associated with a virtual address. For example, a given owner may enter a set of addresses that are associated at different times with an owned virtual address (“JOE DOE” may at times designate a home address, an office address, or a vacation address, and the owner may use the Web interface to reassign an owned virtual address to a different one of these locations as she or he moves from place to place). By separately storing the location information for different physical locations in different rows of the LOCATION TABLE, the owner can reassign the virtual address to a physical location used earlier without re-entering the data describing that location. Data stored in all of these tables can be accessed in essentially any form desired using existing database query techniques, such as SQL.

The server 101, or some other program on another computer 107, 109 or 110, may create data relating to virtual addresses, their owners, and the physical locations to which they refer. For example, a carrier's system may track shipments, and information on the status and history of shipments to or from a given virtual address (that is, both incoming shipments to and outgoing shipments from a given virtual address) may be posted to the OWNER DATA section in the rows of the OWNER TABLE for the owner(s) of those virtual addresses, or data on shipments to or from a given physical location may be stored in the LOCATION DATA section of the row in the LOCATION TABLE corresponding to that physical location.

Item Tracking

Tracking can be readily performed since, when each physical item passes through a distribution node (illustrated at 112-116 in FIG. 1) where its virtual address is captured and used to obtain routing information about the physical location associated with that virtual address, the request message to the server 101 seeking routing information may be logged by the server and may contain additional information such as the sender's virtual address, the virtual address of the distribution node, the time when the item entered or left the node, and an item designation (such as the Electronic Product Code (EPC) read from an RFID tag on the item).

The EPC Network now being implemented for tracking packages in the commercial trade distribution chain is described, for example, by the EPC Tag Data Standards Version 1.1 Rev. 1.26 available from EPC Global, Inc., the standards organization that develops and oversees standards for the EPCglobal Network™. With or without a captured item identifier, the virtual addressing system permits tracking of products being sent to or from a given virtual address or physical location, and permits the owner of a virtual address to access this information. Thus, a virtual address owner might visit a Web site and display a list of all of that owner's virtual addresses and a log showing the history and status of all shipments to or from the owned virtual addresses.

The EPC standard specifies several different item designation formats for identifying items, a portion of which is a “serial number” which is assigned at the item source (typically a product manufacturer) to uniquely designate every individual item. This serial number may then be recorded as a barcode or RFBD tag code which may be read or scanned from the item. The EPC standard further specifies ways in which items designated by EPC codes may be tracked using a central server. The procedures specified by the EPC standard and the procedures using virtual addresses that are described here may be readily integrated with those of the EPC Network, allowing the virtual address to be used to direct physical routing and shipment of items designated by EPC codes and to integrate the tracking procedures specified by the EPC standard with the present system. To facilitate tracking, it would be desirable to identify not only the item but also the type of item (e.g., letter, package, pallet, etc.) and to record the weight of the item. This information may then be displayed along with the virtual address of the sender and destination, and the sequence of locations at which the item was scanned or read during shipment, as part of the shipping status and history for each incoming and outgoing item of interest.

It should be noted that the EPC Network contemplates the use of structured location identifiers called GLNs (Global Location Numbers) to provide a standard means to identify legal entities, trading parties and locations to support the requirements of electronic commerce. The GLN is a 13-digit number used to uniquely identify any legal, functional or physical entity. Its basic components are: an EAN.UCC Company Prefix that identifies the “owner” of the location, and a location reference code that identifies a particular location controlled by that “owner,” and a check digit. The 13 digit GLN could be used as a either a virtual address placed in the ACCESS TABLE 104, or as an additional access key identifier used like an email address or phone or fax number, and is already “known” to trading partners. A GLN is, however, not easily usable by others without available data. Thus, the GLN “0702217683061” and the virtual address “ALTOIDS IN ONTARIO” may refer to the same location, but the descriptive virtual address is plainly easier to remember and use. Thus, both the GLN and a descriptive name be registered as virtual addresses by the same owner and associated with the same physical address. The “DUNS+4” number is also widely used in North America as a location identifier, and is also a 13-digit number that was broken into two different pieces: a 9-digit number assigned by Dun & Bradstreet to identify a company or a subset of a company (DUNS) and a 4-digit number assigned by the company or subset to uniquely identify a location within their own domain. As with GLN numbers, DUNS+4 numbers could be registered a virtual addresses with same advantages (the number is commonly “known” and used among trading partners) and disadvantages (it is another multi-digit number that is hard to remember and hard to use by humans); hence, it is desirable to use such numbers in as access keys used in addition to, rather than virtual addresses used in descriptive shorthand virtual addresses that are much more meaningful and easy to remember for human readers, if not for machines.

Registering a Unique Character String as a Virtual Address

Each “virtual address” comprises a unique string of alphanumeric characters. These characters may be arbitrary, and need not have any intrinsic meaning. However, in the usual case, virtual addresses which are descriptive and easy to remember will be chosen by adopters. For example, people can register their own names or nicknames, such as “Elmer Gantry” or “Sweet Old John” (if not already registered) as their virtual address. Companies may choose product names like “Ford Fairlane” or “PC Magazine” as virtual addresses. A person may also register their email addresses, phone number, cellular number, or fax number as a virtual address however, as has been seen, phone numbers and email addresses can usually be better handled as additional descriptors which provide alternative ways to access information that is also accessible by a descriptive character-string virtual address.

A person's email address can be used as either a virtual address or as an additional address designator specified in the ACCESS TABLE. Since an email address such as “jones@aol.com” always includes of the special character “@” sandwiched between a mailbox name “jones” and a fully qualified domain name “aol.com”, when an email address is used as a destination address, the presence of the “@” causes the server to search in the email column of the ACCESS TABLE for a match. Note that, neither email addresses nor virtual addresses are case sensitive; for example, “Joe Doe” and “JOE DOE” refer to the same row in the ACCESS TABLE. In practice, a captured virtual address or email address my be converted to all uppercase letters before it stored in the ACCESS TABLE or used to access data in the ACCESS TABLE.

In general, users may prefer to avoid registering identifiers as virtual addresses which may compromise the user's privacy or security. For example, while a person's social security number would uniquely identify that person, using that number as a publicly known virtual address or alternative identifier could encourage identity theft. Similarly, a person may not wish to reveal their telephone, cellular or fax number, or an identifier from which the physical location of the virtual address holder might be determined. Moreover, none of these numbers is particularly easy for others to remember or use, whereas person's name, or a variation on a person's name, will normally be much easier to remember and use. Because many people have the same names, a memorable variation of a person's name will frequently need to be composed to fulfill the requirement that the name be unique and not match any previously registered name. Thus, while “John Doe” can only be used once, but unique variations like the following will be fun to contrive and easy to remember: “JOE DOE THE DENTIST,” “DOE THE TOOTH GUY” or “PAINLESS JOE DOE.”

For many, revealing their geographical location as part of the virtual address is not only acceptable, but desirable, and can make it much easier to create a unique but memorable descriptive virtual name, such as “SAM JONES ON STATE STREET” OR “YARMOUTH DENTIST.”

There can be significant advantages in associating known identifiers with virtual addresses, or using them as virtual addresses. Thus, registering a person's telephone or cellular number as well as a descriptive virtual address can be a convenience for those who are known to have those numbers readily available. Thus, when talking with a business contact by telephone, a user might simply say, “You can use my phone number as my mailing address.” In the same way and for the same reasons, a person might register their email address as well as a descriptive virtual address.

In the example ACCESS TABLE above, it can be seen that the user has registered “JOE DOE” as his virtual address, and has also registered his email address, and his phone and fax numbers. All of these identifiers are associated with the same physical location (described by a specified row in LOCATION table), and the same owner information (described by a specified row in the OWNER table). A given owner and a given physical location may be identified in more that one row of the ACCESS TABLE.

The method of addressing items and messages for delivery according to the present invention are clearly preferable to conventional methods now used to address physical items and messages. Conventional mailing addresses tend to be lengthy, hard to memorize, cumbersome to enter by hand or keyboard on written or displayed forms, and even harder to enter using devices like cellular phone keypads. Moreover, conventional addresses are subject to change as people relocate, temporarily or permanently, requiring that address information being held by substantially everyone with whom a person deals be updates. Virtual addresses and associated identifiers need not change when a person relocates, and only one entry need be made in the registration database to become immediately effective (even with respect to items already enroute to an earlier designated physical location)—there is no need to separately notify those who use this data of changes to the database. The system allows a single virtual address to have multiple uses, designating a different physical location at different times, and providing access to information about that owners, physical locations, and shipments. The system allows existing identifiers like phone and fax numbers and email addresses (and potentially other existing identifiers like GLNs, DUNNS+4, and social security numbers) to be used for multiple purposes like sending mail, send packages via courier services, send email, place phone calls, send fax transmissions) as well as for accessing data.

The functionality that the system architecture is capable of providing may be deployed in stages. A subset of the functions, such as virtual-to-physical address translation alone, may be initially implemented, with enhancements being added one step at a time as needed. Frequently, the capabilities of the present system may be added as an enhancement to an existing system, such as a postal routing system employing automated address capture and item sorting capability. Examples of such systems are described in: U.S. Pat. No. 6,819,777 issued to Baker et al. on Nov. 16, 2004 entitled “Mail processing systems and methods;” U.S. Pat. No. 6,917,009 issued to Rosenbaum et al. on Jul. 12, 2005 entitled “Method and apparatus for processing mail pieces;” and U.S. patent application 20040065598 filed by Ross et al. and published Apr. 8, 2004 entitled “Address disambiguation for mail-piece routing,” the disclosures of which are incorporated herein by reference.

New virtual addresses may be allocated by a carrier, such as the U.S. Postal Service, FedEx, or UPS, to its customers. All of the physical address information and other data that frequently needs to be entered manually for every shipment would be entered only once by the customer at registration time and associated with the allocated virtual address and other registered identifiers. The data entered may be restricted to the sole use of the carrier, or to a limited class of participants agreed to by the customer supplying the data. Like phone numbers, the customer may retain the right to transfer a virtual address to the system of another carrier. Plural carriers each operating their own registration and database systems may be allowed to share data with each other solely for the purpose of insuring that allocated virtual addresses are unique across multiple systems.

When a package is received by a carrier, the virtual address on the package may be captured by hand or by automatic character recognition. Note that the simpler virtual address can be much more easily recognized than a normal mailing address. The physical item may then be distributed through a series of distribution nodes as discussed above in conjunction with FIG. 1. As noted above in the case of the postal service, it may be desirable for the carrier to apply a more easily scanned barcode or the like which contains the virtual address (and an item designation), or a coded destination designation, to the item for more rapid and accurate scanning at the distribution nodes. In addition, a full printed mailing address which can be read by human can also be fetched (from the PRINT AS column of the LOCATION DATA TABLE) and printed on the item. Alternatively, instead of applying a printed label, the virtual address and item identifier may be stored in an RFID tag affixed to the item. The placement of a physical destination address information on the item will, in some cases, facilitate delivery to the particular location for drop of by a delivery truck or the like, and would enable the driver to visually confirm that the item being delivered is in fact directed to that location.

Notifications and Messages

As seen in the example ACCESS TABLE above, each registered virtual address, phone number and fax number is preferably associated in a table row with an email address (and perhaps a Web services Internet address) to which notification messages may be sent. The notification address may be an email address to which advisory email messages is sent, or may be the URL of a callable procedure such as a Web service that permits programmatic notifications to be sent to the virtual address owner. For example, the virtual address owner may provide the address to which notification messages may be sent providing tracking data regarding items being sent to or from a given virtual address.

Alternatively, or in addition to an email address and one or more callable procedure addresses, the OWNER DATA may specify the URL of a Web site operated on behalf of the owner which any person may visit and access any information or function the owner wishes to make available. The registration server, or some other provider, may create a template Web site based on the information entered during registration, and the virtual address owner could then modify or enhance this Web site as desired. As a further variation, domain name space may be allocated to virtual addresses. For example, a cellular phone company could automatically register cellular phone numbers as virtual addresses, and also provide each cellular phone with a corresponding domain name joined with a new upper level domain name, such as “.num”. Thus, for example, anyone who received a phone call from 978-808-3482 may easily access the corresponding Web site at http://www.9788083482.num and obtain personal information about that person.

Because one or more notification Internet addresses can be stored and associated with a particular virtual address, the carrier may operate a “forwarding facility” which receives data directed to a virtual address, repackages it if necessary into proper form transmission to a particular Internet address (such translating data into email format for transmission to a mailbox designated by an email address), and automatically forwards it to the designated notification address. Accordingly, just as an email address can be used to send physical items to a destination, or place calls or send fax transmissions to a particular associated PSTN number, any of the other designators can be used as an email address by an email client or server. An email client program may include the ability to recognize virtual names or phone or fax numbers placed in the TO, CC, or BCC fields of an outgoing email message, and automatically interrogate the remote server to obtain and substitute the corresponding email addresses from the ACCESS TABLE, and then direct the outgoing email to the fetched email address or addresses.

In the same way, the phone and fax numbers registered in the ACCESS TABLE may b used by an autodialing program executing on a personal computer which accepts a virtual address or email address, consult the database 103 via the Internet to obtain a related phone or fax number, and automatically dial the retrieved number, thereby allowing the PC user to automatically establish a telephone connection or send fax transmissions to the owner of a virtual address when the owner's email address or virtual address is known. In the same way, the public switched telephone network (PSTN) and/or a cellular network may accept keyboarded virtual addresses or email addresses and establish a telephone connection to the owner of those addresses. Knowing a person's phone number, the system can return that person's related fax number.

As discussed above, the system enables virtual addresses and existing designators to be used across multiple communication networks. As still another example, if a person's cellular phone number was registered, it could also be used as a mailing address, an email address, an identifier of a Web page operated by the cellular phone owner. A single registered unique identifier thus becomes a multi-use address for handling communication and deliveries via multiple carriers and multiple communications pathways.

The owner of a virtual address may establish and store rules which specify a preferred sequence of channels which are to be attempted. Thus, the owner may indicated that communications to him or her should be first attempted by telephone, but if a telephone connection cannot be established to a first telephone number, then an attempt should be made to establish a connection to a second telephone number, and if that fails, an email notification message should be sent to a designated email address, and if all else fails, a fax message should be transmitted. These stored rules may be accessed by different carriers and networks or forwarding services so that communications with a registrant are established in ways preferred by the registrant.

In general, the data in the database 103 should be private and secure. The data may be encrypted, exchanged with others only via secure transmission pathways such as HTTPS, the Secure Hyper Text Transport Protocol, and accessible only to those authorized by registrants who supply the data to receive it. The importance of security cannot be overemphasized. For the system to provide many of its most useful functions, it must contain data which should be provided to authorized recipients but clearly should not be allowed to become available to those who may misuse it for improper purposes ranging from identity theft to the dissemination of unwanted advertising to addresses improperly extracted from the system.

With proper procedures, however, the system can offer substantially more privacy and data protection than is afforded by conventional methods in use today. The system allows information which needs to be delivered to others to be entered only once into the system, where it is secure, and to thereafter be delivered to only to others who are authorized to receive it via secure pathways, and only provided to the extent the recipient has a need to know that information. Because information is dynamically delivered, it need not be and should not be stored even by the recipient for future use. Rather, only one secure copy should exist on the secure database server. The use of virtual addresses and other designators on physical shipments can hide or obscure the identity or geographic location of a person to whom a shipment or message is directed whereas conventional shipping addresses clearly fail to do that.

Accounting Efficiencies

A carrier may bill an owner of a virtual address for services, supplies and shipping costs associated with shipments to and from a virtual address. Thus, the use of different virtual addresses would permit a customer to not only direct mail to a particular location but also to separately track, monitor and pay for shipments to and from each separate virtual address.

The owner of a virtual address may agree to pay for all shipments to a particular virtual address, making it easy, for example, for a company to pay for the shipment of items being returned to a specific virtual address registered for that purpose. Rules stored for particular virtual address may direct that charges for shipments to that virtual address will be paid by the recipient if the sender is identified by one or more specified virtual addresses which are entitled to free shipping.

The owner of virtual address may request the carrier to quote shipping charges and estimated delivery times for items of a particular weight or kind to be delivered to one or more virtual addresses. If the physical location associated with an destination virtual address is made after a quote, or after the shipper prepays charges, the carrier may provide a mechanism for obtaining authorization to proceed with the shipment if additional costs are incurred, or to credit the shippers account if lower charges are incurred due to the address change. Alternatively, the virtual address holder may be required to pay for any excess charges that result from redirecting packages to a new physical address associated with that virtual address.

Mobile Addresses

Another benefit of the system is provided by the ease with which addresses and other data can be changed. A registrant may move to any number of new physical addresses for any period of time and by merely notifying the central database, packages and mail would be re-routed to the new address. This would be particularly valuable for traveling business people, families with second homes, families on vacation, or for businesses or families that had moved.

Particular items, or different senders, could be assigned different priority levels, and only the most important packages be forwarded would “track you down” while others would be directed to a normal location. Note that this is actually a special case of a more general rules-based capability discussed above for providing conditional rerouting of items, originally directed to a particular address, to a different virtual address if a specified condition is satisfied.

In the case of such a move or temporary relocation, and in the interest of privacy, senders could be prevented from knowing that the recipient had moved or was at a new address temporarily. This is current Post Office policy. Alternatively, senders who participated in the carrier's system by obtaining their own virtual address or otherwise had accounts with the carrier, could be notified via email of changes of addresses associated with recipients to whom they had sent packages when such recipients allowed such notification.

In one scenario, a person might be traveling extensively with an uncertain schedule or not have time to deal with incoming packages. In that case, rules could be associated with a registrant would direct the carrier to hold or freeze in place the registrant's packages until such time as it made sense to forward them. This would be the equivalent of leaving email on the server until such time as it could be downloaded. This would require the carrier to maintain a storage capability and a mechanism for ultimately delivering or disposing of accumulated items.

Multiple Virtual Addresses

A registrant may register several different virtual addresses (and corresponding designators like phone and fax numbers); that is, may place data in several different rows of the ACCESS TABLE. This permits a registrant to register an arbitrarily large number of virtual addresses and other identified and relate them all to the same or different physical addresses. A registrant might use different addresses and designators for different purposes. Different virtual addresses could be associated; for example, with product promotions (GM could register “Best Made Cars” for a period of time during a promotion. Alternatively, a series of addresses could be purchased, like: “Best in Snow”, “Best in Mileage”, “Best Value” where the sender's choice of address used could convey information to the recipient.

Virtual Return Addresses

In the same way items can be directed to virtual addresses or related designators that are related to physical address information, senders can place their own virtual addresses and designators in readable form on outbound items, and as contact information in advertising and on Web sites. The presence of the sender's unique identifier on an outbound package enables the carrier to perform billing, tracking, and notification functions for the sender. In addition, the sender may permit tracking and other notification messages to be sent via email or in other ways to the recipient, or make the data available to the recipient on request. As previously discussed, the owner of a virtual address designate what portions of the stored data relating to that virtual address may be revealed, and the entities to whom it can be revealed.

Note that it is possible for sender and recipients designated by virtual addresses to remain anonymous to others even while the carrier had access to the sender's physical address in case it was needed. This level of privacy could be selected by the Sender either on an occasional basis or for every item sent. Note also that when the sender's address is kept private, the recipient would still be able to reply to the sender by using the virtual address to deliver a physical item, or as an Internet address using the forwarding facility discussed above).

Sender Plus Shorthand Destination Names

A virtual address holder may store, for each owned virtual address, a collection of shorthand recipient designations and corresponding destination virtual names. Thus, the owner of the virtual address JOE DOE could store the following relationships:

| SHORTNAME | VIRTUAL NAME |
|---|---|
| M | MARY K DOE |
| R | ROBERT STURGIS |
| C | COMMONWEALTH EDISON CHICAGO |
| S | SBC HOUSTON ETC. |

Then, the sender could apply the following simple label to an outgoing item “JOE DOE/C” which indicates that the item is from the virtual address JOE DOE and is being sent to the virtual address (COMMONWEALTH EDISON CHICAGO) which corresponds to the shortname C which has been associated with JOE DOE in the database.

This simple mechanism makes it easy to address many common items using, for example, an ink stamp reading “JOE DOE/” and then simply adding the shortname to the item after the “/”.

Paying for Names

People, organizations, and businesses typically place high values on their trademarks and servicemarks, brand names, slogans and vanity representations. This importance of unique and memorable names and the like is evidenced by sums exchanged to settle trademark litigation, the size of the market for domain names and easy-to-remember mnemonic 800 numbers. Clearly people and companies are willing to pay for short, meaningful, and/or memorable virtual names. Thus, under one business model, the cost of implementing the system may be born in whole or in part by revenue derived from selling (or renting) virtual names. Certain classes of names (e.g. registered trademarks) may be available only to the trademark registrants who are required to pay for each registration. Other classes of virtual addresses or related identifiers, such as phone numbers, or the GLNs or DUNNS+4 numbers noted earlier, may be allocated for distribution only by the organization that allocates those numbers in the first instance, thus providing a revenue generating mechanism which provides the benefits of the virtual address system to that organizations users. Other common names that may be in demand (like dictionary words) could be made available only for an additional fee. The use of a name in combination with a geographic name such as “DEBBIE OF PLYMOUTH”, as noted earlier, vastly increases the likelihood that an easy to remember virtual name can be chosen, and the registration of a virtual name that includes a geographic name may require an additional fee to provide additional revenue. Similarly, a charge may be made for the use of “shortnames” for destinations associated with the virtual address of a sender as described earlier.

Central Shared Registration

It would be likely that multiple carriers would wish to offer virtual addresses to their customers. If a person or business had to have different virtual addresses for each, however, it would defeat the goal of simplification if these addresses were not standardized among carriers. A single virtual address should preferably be usable with all carriers. Ideally, then, it would be desirable to have a third party that would permit customers to register a virtual name that can then be used with all carriers and for multiple purposes. This entity could then charge participating carriers based on the extent the system is accessed to provide virtual-to-physical address translation and other functions. Under that model, registration could be free to subscribers and the cost born by the carriers who benefit significantly from increased efficiencies. Or the registration facility could charge a registration fee, and the proceeds could be shared by sponsoring carriers.

Geography

As seen in the example LOCATION TABLE given above, a physical location that is associated with a virtual address may be specified not only by a mailing address but also by (or instead by) geographic coordinates (latitude and longitude). This inclusion of geographic coordinates facilitates the implementation of a number of functions. For the carrier, the coordinates may be used in combination with a GPS navigation and route planning system to guide delivery trucks to the proper destination. For those who want information about a location, the coordinates allow mapping software using both graphical maps and satellite imagery (such as now offered by Google Maps, Yahoo and MapQuest) to display the location associated virtual address on a map. Increasingly, GPS navigation systems are coupled to the Internet to provide live traffic data, a such connection could also be used to allow a driver to key in a virtual address of a desired destination, and the navigation software could then calculate a route to that destination. Similarly, an Internet mapping program such as MapQuest could accept a virtual address and then present a map showing that location, or calculate a route between two virtual addresses and display the resulting route to a requestor.

The geographic data and telephone number data associated with a virtual address in the database may be employed to implement a virtual communications network with persons in a particular geographic location a described in the above-noted James Logan U.S. Pat. No. 6,788,766, the disclosure of which is incorporated herein by reference. As described in that patent, a virtual communications network may be created between a group of consenting participants, each of which transmits a first message to a central location identifying that participant's telephone number, its geographic location, and additional descriptive information characterizing the party. Since the needed information is already associate with a virtual address, it is only necessary for the owner of a virtual address to submit the virtual address to the submission to initiate participation in the network. When a query is submitted from a third party to the virtual communications network specifying a desired location and further desired characteristic of a desired called party, the central location may then respond with by sending the requestor the virtual address of a matching consenting participant in the network. Thus, for example, if guidance is sought concerning the selection of a good restaurant in Savannah, the virtual communications network can respond by supplying the virtual address or addresses of participants in Savannah who may be able to supply that information. Given the virtual address, the person submitting the query may then mail an inquiry to that virtual address, send an email to that virtual address, place a phone call to that virtual address, or consult a Web site for that virtual address.

Physical Delivery Services

Email users receive email only when requested; that is, the email messages are stored on an incoming a mailbox server until they are downloaded to the mailbox owner. This ability to obtain and deal with incoming material when requested, instead of needing to deal with it whenever it might be delivered, is normally desirable.

An analog to the email mailbox server can be provided as a service offered by carriers, such as the Postal Service of a delivery carrier, or by and independent receiving service designated as the physical location corresponding to a virtual address. This would be a local facility where packages and mail for a person or business would be sent, a function served by private mailboxes today.

Once at this facility, each piece of mail could be processed, and an image of the piece, along with any relevant information (weight, size, time of delivery, etc.) emailed to the customer (using the email address corresponding to the virtual address to which the piece is directed). The customer could then decide on-line whether or not he or she wished for any specific piece to actually be delivered.

Such a system would have the major benefit of allowing junk mail to be disposed of at a central facility where disposal could be done more efficiently and in a more environmentally-friendly fashion. No longer would a person have to clean a dozen redundant catalogs out of a mailbox each day, lug them into the house, throw them out, and then once a week collect them all up for disposal or recycling.

A user could request that a letter or package be opened and more of its contents scanned and emailed. In this manner, an important letter or bill could be immediately seen and dealt with.

As physical communications becomes relatively less important, dealing with incoming items in this delegated way reduces the physical work needed to manage the flow. A further benefit would be realized by people traveling, who could get instant actionable access to much of their mail without having to wait for items to be rerouted to their new address.

To further reduce the work of processing the flow, users could designate certain publications, or types of materials as not desired. Much as spam filters delete email before a user ever sees it, the server facility could reject such items. Thus, if a user were tired of receiving a new Victoria Secret catalog each day, such catalogs could be designated as “mail spam” and discarded “upstream” at the server facility. As noted earlier, sing rules based conditional rerouting, when it unwanted items can be identified from the source designation, item type, weight, etc. available, the system may automatically redirect the unwanted mail to the virtual address of the sender, so that in never arrives at the destination site, eliminating the need to process or dispose of it.

Note also that the virtual address could store a list of virtual addresses from which it will not accept, and will return to sender, any item directed to a given virtual address from a specified virtual address. A mass distributor can consult this list in advance via the Internet to identify virtual addresses that will not accept shipments and thereby avoid the shipments in the first instance. In effect, then, the storage of a list of source addresses from which shipments will not be accepted, or the storage of other stated conditions upon which shipments will be decline or returned, can operate as a “Do No Ship” list comparable to the “Do Not Call” lists now published to help prevent unwanted phone calls.

For users who would want to have the ability to change their mind at some point about such disposal, this material could be scanned and the results put into a “bulk mail” folder that the user would have to actively retrieve. In this manner, the scanned data would have to be “pulled” by the user as opposed to being “pushed” by the server facility via email. The facility could then archive the physical material for some period of time and dispose of it upon request or until a set length of time had expired with no request by the user to have the material sent.

Another feature of the server approach would be to allow users to store materials at the server location. Using the analogy of email folders, the user could click on a scanned image and request that it be archived in a folder and handled in a certain fashion. If this were done after having the inside contents scanned, this storage could suffice for as long as the document was needed and never be delivered to the user's residence . An analogous feature to password protection would allow the user to review the scanned images of documents in order to control their delivery to a household or business. If one were expecting the delivery of a surprise birthday present intended for another member of the household, the registered user could recognize that the package was at the location of the server and request that it be delivered later or even go pick it up at the server location. In addition, the customer could request that the received item be forwarded to any specified virtual address.

Server Implementation

The system may be readily implemented by a conventional, available hardware and software. A relational database management system (RDBMS) may be used for storing cross-references and related data, a conventional Web server may be used for performing registration and data maintenance functions, and a directory server such as an LDAP (Lightweight Directory Access Protocol) server may be used for performing high speed lookups which enable requestors to convert a virtual address, a phone or fax number, or an email address into a different address used for a different purpose. Some or all of these servers may be mirrored by other servers for load sharing and redundancy. The data may be distributed among different servers which operate on a master slave relationship; for example, high speed lookups may be performed using the distributed Domain Name System, or a derivative thereof. Lookup operations may be divided among different servers or sets of servers along functional lines; for example, one set of servers may respond solely to requests containing virtual address strings and returning mailing address data and be used by one or more postal services or private delivery services, whereas another set of servers may respond solely to requests containing phone or fax numbers and return email addresses and be used primarily by email client and server programs that can redirect email directed to phone or fax, numbers to equivalent email mailbox addresses.

Conclusion

It is to be understood that the methods and apparatus which have been described above are merely illustrative applications of the principles of the invention. Numerous modifications may be made by those skilled in the art without departing from the true spirit and scope of the invention. In practical applications of the principles of the invention, specific hardware and software, as well as the schemas chosen to represent data, will be selected based on the needs of each application and will typically represent a subset of the features, functions and data described above, while, in other applications, additional data relating to particular persons, entities or locations that are designated by virtual addresses or by related existing identifiers will be stored, used to facilitate different forms of queries, and used to provide additional useful data to requesters to implement functions not specifically disclosed here. These and other modifications are to be expected in systems which utilize the invention.

1. A method for delivering a physical item to a specific destination location comprising, in combination, the steps of:
storing cross-references in a database server connected to the Internet, each given one of said cross-references consisting of:
a virtual address portion comprising a unique character string that identifies said cross-reference, and
a location specification portion that describes a specific geographic location, placing the virtual address portion of a selected one of said cross-references on said physical item,
transferring said physical item to the custody of a carrier for delivery,
employing said database server to accept to a request transmitted via the Internet from said carrier containing said virtual address portion placed on said physical item,
in response to said request, returning to said carrier a response message containing all or part of the location specification portion of said selected one of said cross-references, and
delivering said physical item to the geographic location specified by said location specification portion of said selected one of said cross-references.

2. A method for delivering a physical item to a specific destination location as set forth in claim 1 wherein said carrier employs optical scanning means for capturing said virtual address portion from said physical item.

3. A method for delivering a physical item to a specific destination location as set forth in claim 1 wherein said carrier employs data contained in said response message to route said physical item for deliver to said geographic location.

4. A method for delivering a physical item to a specific destination location as set forth in claim 1 wherein said database server stores tracking data based on messages received from said carrier containing said virtual address portion.

5. A method for delivering a physical item to a specific destination location as set forth in claim 1 further including the step of:
accepting at least a plurality of said cross-references via the Internet from registrants each of whom supplies one of said unique character strings as the virtual address portion of a particular one of said cross-references and a description of a geographic location as the location specification portion of said particular one of said cross-references.

6. A method for delivering a physical item to a specific destination location as set forth in claim 5 wherein at least some of said cross-references further include a telephone number accepted from a registrant to whom telephone calls may be directed.

7. A method for delivering a physical item to a specific destination location as set forth in claim 6 wherein at least some of said cross-references further include an email mailbox address accepted from a registrant to which email messages may be directed.

8. A method for delivering a physical item to a specific destination location as set forth in claim 6 wherein at least some of said cross-references further includes a telephone number accepted from a registrant to which facsimile transmissions may be directed.

9. A method for delivering a physical item to a specific destination location as set forth in claim 1 further including the step printing or otherwise attaching information contained in one of said response messages onto said physical item.

10. An information server connected to the Internet for responding to a request message containing a first address of a particular person, entity or geographic location by returning a response containing one or more alternative addresses related to said first address, said information server comprising, in combination,
a database for storing a plurality of cross-references, each of which contains a string of printable characters which forms a unique identifier of a person, entity or location, and further contains one or more related addresses to which communications may be directed to a said person, entity or location, each of said related addresses being selected from a group comprising:
a mailing address for said particular person, entity or location,
a telephone number assigned to said person, entity or location,
a telephone number assigned to a facsimile transceiver operated on behalf of said person or entity or positioned at said location,
an email mailbox address assigned to said person, entity or location, and
the URL specifying the location at which a Web page or other resource containing information about said person, entity or location may be accessed via the Internet,
means for accepting a request message from a requester via the Internet that contains either a given one of said strings or a given one of said related addresses,
means for accessing the particular one of said cross-references that contains either said given one of said strings or said given one of said related addresses, and
means for returning to said requestor via the Internet a response message that includes data contained in said particular one of said cross-references.

11. An information server as set forth in claim 10 further including a Web server connected to the Internet for accepting data from a registrant, means for placing said data in a new cross-reference, and means for storing said new cross-reference in said database.

12. An information server as set forth in claim 11 wherein said Web server further includes means for accepting revision commands from a registrant who previously stored a specific cross-reference, means for altering the data contained in said specific cross-reference in response to said revision commands, and means for storing the specific cross-reference as altered in said database.

13. An information server as set forth in claim 10 wherein said requestor is a postal service or other carrier that delivers physical items, wherein said request message contains a given one of said strings or one of said related addresses other than a mailing address, and wherein the data included in said response message comprises all or part of a mailing address.

14. An information server as set forth in claim 10 wherein said request message contains a given one of said strings and wherein said response message includes one or more or said related addresses contained in said particular cross reference.

15. An information server as set forth in claim 14 wherein said response message contains the telephone number assigned to said person or entity that is contained in said particular cross-reference.

16. An information server as set forth in claim 14 wherein said response message contains the email address assigned to said person or entity that is contained in said particular cross-reference.

17. An information server as set forth in claim 10 wherein said request message contains a given one of said related addresses contained in said particular cross-reference and wherein said response message contains a different one of said related addresses contained in said particular cross reference.

18. An information server as set forth in claim 10 wherein said request message contains a telephone number assigned to said person, entity or location and wherein said response message contains the mailing address contained in said particular one of said cross-references.

19. An information server as set forth in claim 10 wherein said request message contains a given one of said strings and wherein said response message contains the mailing address contained in said particular one of said cross-references.

20. An information server as set forth in claim 10 wherein said request message contains an email address and wherein said response message contains one or more related addresses contained in said particular cross reference.
